(19) United States
(12) Patent Application Publication
(10) Pub. No.: US 2026/0269101 A1
(43) Pub. Date: Sep. 10, 2026

(54) WIRE HARNESS

(71) Applicant: SUMITOMO WIRING SYSTEMS, LTD., Yokkaichi-shi, Mie (JP)

(72) Inventors: Kosuke TANAKA, Yokkaichi-shi (JP); Katsutoshi IZAWA, Yokkaichi-shi (JP); Ryo FUJIOKA, Yokkaichi-shi (JP)

(73) Assignee: SUMITOMO WIRING SYSTEMS, LTD., Yokkaichi-shi, Mie (JP)

(21) Appl. No.: 19/164,877

(22) PCT Filed: Feb. 26, 2024
(86) PCT No.: PCT/JP2024/006784

§ 371 Date: Sep. 12, 2025

(30) Foreign Application Priority Data
Mar. 14, 2023 (JP) 2023-039650

(51) Int. Cl. H01B 7/00; B60R 16/02; H02G 3/04

(52) U.S. Cl. CPC H01B 7/009; B60R 16/0215; H02G 3/0468

(57) ABSTRACT

A wire harness including: an electric wire; a braid formed by braiding conductive strands; and an earth terminal, wherein the braid includes a tube that covers the electric wire, and an earth wire that extends, while gathering strands of the earth wire together, from an end of the tube in such a manner as to be separable away from the electric wire, and be connected to the earth terminal; and a holder that is fixed to the electric wire, wherein the holder includes an earth wire holder that holds a portion in an extending direction of the earth wire.

### BACKGROUND

The present disclosure relates to a wire harness.

Heretofore, as wire harnesses, there are wire harnesses provided with electric wires, braided members formed by braiding conductive strands, and earth terminals (for example, see JP 2006-156299A (FIG. 7)). The braided member includes a tubular portion that covers an electric wire, and an earth wire that extends, while gathering the conductive strands together, from an end portion of the tubular portion in such a manner as to be separable away from the electric wire, and is connected to an earth terminal. The earth terminal is connected to a grounding member such as a vehicle body or a metal case. In such a wire harness, for example, noise radiation from the electric wire is suppressed by the braided member.

### SUMMARY

However, in a wire harness such as that described above, the earth wire is not positioned relative to the electric wire, and thus the impedance in a region extending from the tubular portion of the braided member to the grounding member is unstable. Accordingly, there is a problem in that the shielding performance of the wire harness obtained using the braided member is unstable.

An exemplary aspect of the disclosure provides a wire harness in which the shield performance can be stabilized.

A wire harness according to the present disclosure includes: an electric wire member including an electric wire and a braided member formed by braiding conductive strands, and an earth terminal, the braided member including a tubular portion that covers the electric wire, and an earth wire that extends, while gathering the strands of the earth wire together, from an end portion of the tubular portion in such a manner as to be separable away from the electric wire, and be connected to the earth terminal, wherein the wire harness further includes a holder that is fixed to the electric wire, and the holder includes an earth wire holding portion holding a portion in an extending direction of the earth wire.

With a wire harness according to the present disclosure, shield performance is stabilized.

### BRIEF DESCRIPTION OF THE DRAWINGS

FIG. 1 is a partial cross-sectional view of a wire harness according to a first embodiment.

FIG. 2 is a cross-sectional view taken along the line 2 -2 in FIG. 1.

FIG. 3 is a perspective view showing a holder and an exterior member according to the first embodiment.

FIG. 4 is a partial perspective view of a wire harness according to a second embodiment.

FIG. 5 is a cross-sectional view showing a modified example of the wire harness in the first embodiment.

### DETAILED DESCRIPTION OF EMBODIMENTS

### Description of Embodiments of the Present Disclosure

First, a mode for carrying out the present disclosure will be listed and described.

A wire harness according to the present disclosure includes:
[1] an electric wire member including an electric wire and a braided member formed by braiding conductive strands, and an earth terminal, the braided member including a tubular portion that covers the electric wire, and an earth wire that extends, while gathering the strands of the earth wire together, from an end portion of the tubular portion in such a manner as to be separable away from the electric wire, and be connected to the earth terminal, wherein the wire harness further includes a holder that is fixed to the electric wire, and the holder includes an earth wire holding portion holding a portion in an extending direction of the earth wire.

With this configuration, since the earth wire holding portion is provided in the holder fixed to the electric wire, the position of the earth wire relative to the electric wire can be stabilized. For this reason, the impedance in a region extending from the tubular portion of the braided member to the earth terminal connected to the grounding member is stabilized. Accordingly, the shielding performance is stabilized.
[2] In the above [1], the wire harness may further include: a cylindrical exterior member that covers the electric wire member, and the holder may be attached to an attachment end portion that is one end portion in a lengthwise direction of the exterior member.

With this configuration, the holder including the earth wire holding portion is attached to the attachment end portion that is one end portion in the lengthwise direction of the exterior member. Accordingly, the earth wire extending from the braided member can be held near the end portion in the lengthwise direction of the exterior member.
[3] In the above [2], the holder may include: a cylindrical insertion portion that is inserted into the exterior member, and a flange portion that extends outward from the insertion portion, the electric wire may pass through the insertion portion, and the flange portion may face the attachment end portion in the lengthwise direction of the exterior member.

With this configuration, the flange portion of the holder makes it possible to keep the electric wire from interfering with the attachment end portion of the exterior member.
[4] In the above [3], the earth wire holding portion may be formed to extend through the insertion portion in a radial direction, and the earth wire may be passed from inside of the insertion portion to outside.

With this configuration, the earth wire can be passed through the insertion portion of the holder to the outside of the insertion portion.
[5] In the above [4], the exterior member may include a slit through which the earth wire is passed.

With this configuration, the earth wire can be passed through the slit in the exterior member to the outside of the exterior member.
[6] In the above [5], the earth wire holding portion may include a positioning portion engaging with the slit in a circumferential direction when inserted into the slit.

With this configuration, due to the positioning portion of the earth wire holding portion being engaged with the slit of the exterior member in the circumferential direction, the earth wire holding portion and the slit of the exterior member are positioned relative to each other in the circumferential direction. Therefore, the position of the slit of the exterior member relative to the electric wire member in the circumferential direction, that is to say, the pull-out position of the earth wire can be determined.
[7] In any one of the above [2] to [6], the wire harness may further include a fastening member fixing the holder to the electric wire, and the holder may include a fixed piece that is fastened and fixed along with the electric wire by the fastening member.

With this configuration, since the holder is fixed to the electric wire by the fastening member, it is possible to more stably hold the holder and the earth wire held by the earth wire holding portion of the holder.
[8] In the above [1], a plurality of electric wires may be provided, the holder may be a cable tie bundling the plurality of electric wires, the cable tie may include a band portion that is wound around the electric wires, and a lock portion provided integrally with a base end portion in a lengthwise direction of the band portion, and locked with the band portion whose leading end portion is inserted into the lock portion, and the earth wire holding portion may be provided in the lock portion.

With this configuration, the position of the earth wire relative to the electric wires can be stabilized using the earth wire holding portion provided in the cable tie that bundles the electric wires.

### Detailed Embodiments of Present Disclosure

Specific examples of a wire harness of the present disclosure will be described below with reference to the drawings. In the drawings, parts of the configurations may be shown in an exaggerated or simplified manner for convenience of description. Moreover, dimensional ratios of portions may be different between figures.

### First Embodiment

A wire harness according to a first embodiment will be described below.

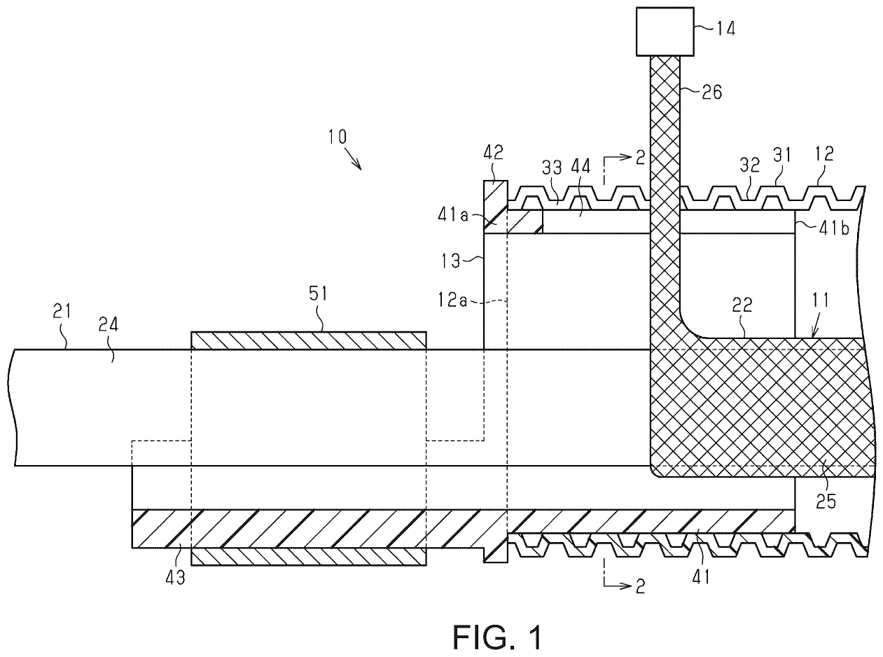

A wire harness 10 according to the present embodiment shown in FIG. 1 is routed in a vehicle, for example, to electrically connect onboard devices provided in the vehicle. The wire harness 10 includes an electric wire member 11, an exterior member 12 that covers the electric wire member 11, a holder 13 attached to the exterior member 12, and an earth terminal 14.

### Electric Wire Member 11

The electric wire member 11 includes an electric wire 21 and a braided member 22 (braid) that covers the electric wire 21.

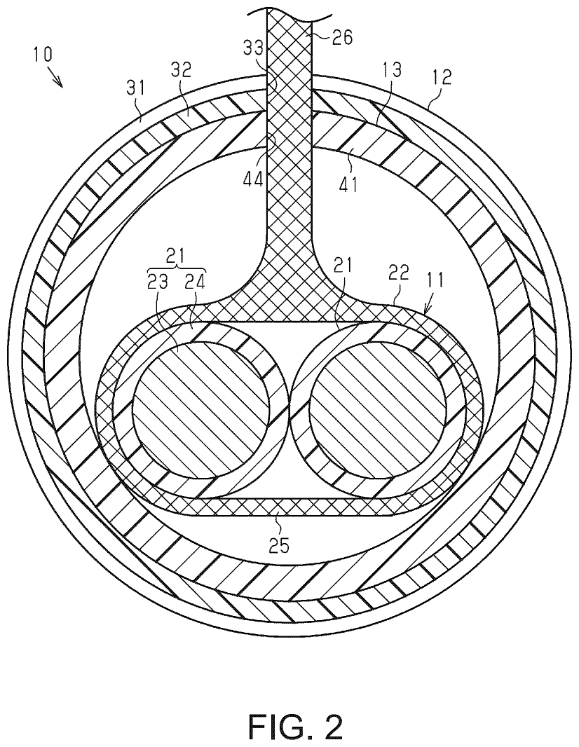

As shown in FIG. 2, the wire harness 10 includes a plurality of electric wires 21, for example. The wire harness 10 according to the present embodiment includes, for example, two electric wires 21. The electric wires 21 each include a core wire 23 and an insulating coating 24 that covers the core wire 23.

The core wire 23 is, for example, a stranded wire formed by twisting together a plurality of conductive strands, a columnar conductor formed of a single columnar metal rod having a solid internal structure, or a tubular conductor having a hollow internal structure. The core wire 23 may also be a combination of multiple types of conductors, such as a stranded wire, a columnar conductor, and a tubular conductor. Examples of the columnar conductor include a single-core wire and a bus bar. As the material of the core wire 23, for example, a metallic material such as a copper-based or aluminum-based material can be used.

The insulating coating 24, for example, covers the entire outer circumferential surface of the core wire 23. The insulating coating 24 is made of an insulating material such as a synthetic resin. As the material of the insulating coating 24, a synthetic resin mainly composed of a polyolefin-based resin, such as cross-linked polyethylene or cross-linked polypropylene, is used. The insulating coating 24 may be formed of a single material alone, or may be formed by combining two or more materials as appropriate.

### Braided Member 22

The braided member 22 is formed by braiding conductive strands. Note that the drawings schematically illustrate a state where the strands of the braided member 22 are braided. As the material of the braided member 22, a metallic material such as a copper-based or aluminum-based material can be used.

The braided member 22 includes a tubular portion 25 (tube) that covers the electric wires 21, and an earth wire 26 that extends, while gathering the strands together, from an end portion in the lengthwise direction of the tubular portion 25 in such a manner as to be separable away from the electric wires 21. The tubular portion 25 according to the present embodiment collectively covers the two electric wires 21. That is to say, the braided member 22 according to the present embodiment is a multi-core collective shield member. The earth wire 26 is formed as a single conductive wire, for example, by the strands being gathered and twisted together from the end portion in the lengthwise direction of the tubular portion 25, and is configured to be bendable in a direction different from the extending direction of the electric wires 21.

### Earth Terminal 14

As shown in FIG. 1, an earth terminal 14 made of a conductive material is attached to a leading end portion of the earth wire 26. As the material of the earth terminal 14, a metallic material such as a copper-based or aluminum-based material can be used. The earth terminal 14 is electrically connected to the earth wire 26, for example, through crimping or the like. The earth terminal 14 is electrically connected to a grounding member such as a vehicle body panel (not shown) by being fixed thereto, for example. Accordingly, the braided member 22 that includes the earth wire 26 is connected to the grounding member via the earth terminal 14.

### Exterior Member 12

As shown in FIGS. 1 and 2, the exterior member 12 is formed in a tubular shape that covers the electric wire member 11. The exterior member 12 protects the electric wire member 11. The exterior member 12 is, for example, formed in a cylindrical shape. The exterior member 12 covers a portion in the lengthwise direction of the electric wire member 11, for example.

The exterior member 12 is, for example, a corrugated tube having a bellows structure in which large-diameter portions 31 and small-diameter portions 32, which have a smaller diameter than the large-diameter portions 31, are alternately arranged along the lengthwise direction of the exterior member 12. That is to say, the exterior member 12 is made easily bendable due to the bellows structure. As the material of the exterior member 12, a synthetic resin such as polyolefin, polyamide, polyester, or ABS resin can be used.

A slit 33 extending in the lengthwise direction is provided in a portion of the circumferential direction of the exterior member 12. The slit 33 is formed, for example, along the entire length of the exterior member 12. Accordingly, the exterior member 12 can be attached to the electric wire member 11 from the outside of the electric wire member 11. In other words, the exterior member 12 can be retrofitted onto the electric wire member 11 using the slit 33. For example, the exterior member 12 can be disposed to cover the electric wire member 11 from the outside of the electric wire member 11 after a portion of the electric wire member 11 has been processed.

### Holder 13

As shown in FIG. 1, the holder 13 is attached to an attachment end portion 12a, which is one end portion in the lengthwise direction of the exterior member 12. The holder 13 is made of a resin. As the material of the holder 13, a synthetic resin such as polypropylene, polyamide, or polyacetal can be used. The holder 13 prevents the attachment end portion 12a of the exterior member 12 and the electric wires 21 from coming into contact with each other. That is, the holder 13 protects the electric wires 21.

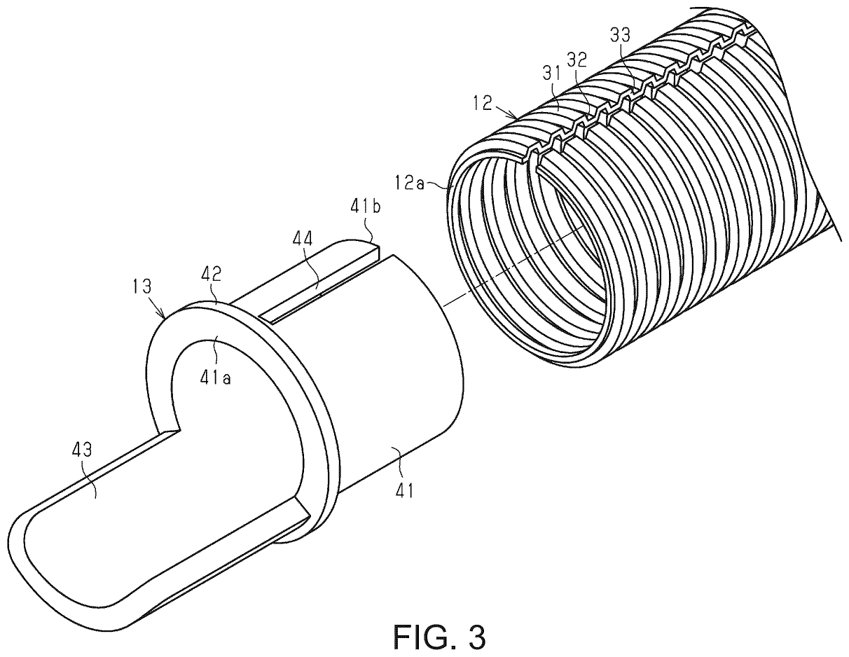

As shown in FIGS. 1 and 3, the holder 13 includes, for example, an insertion portion 41, a flange portion 42, a fixed piece 43, and an earth wire holding portion 44 (earth wire holder).

The insertion portion 41 is formed in a tubular shape. The insertion portion 41 is inserted into the exterior member 12 from the attachment end portion 12a along the lengthwise direction of the exterior member 12. The outer circumference surface of the insertion portion 41 is in contact with the inner circumference surface of the exterior member 12. In a case where the exterior member 12 is a corrugated tube, the outer circumference surface of the insertion portion 41 comes into contact with the inner circumference surfaces of the small-diameter portions 32 of the exterior member 12.

The insertion portion 41 has a locking protruded portion (not shown) that protrudes from the outer circumference surface of the insertion portion 41. This locking protruded portion catches on the inner circumference surface of the exterior member 12 in the lengthwise direction of the exterior member 12. Accordingly, the insertion portion 41 is kept from coming loose from the exterior member 12. Note that, in a case where the exterior member 12 is a corrugated tube, the locking protruded portion of the insertion portion 41, for example, catches on a step between a small-diameter portion 32 and a large diameter portion 31 on the inner circumferential surface of the exterior member 12. The electric wires 21 pass through the insertion portion 41.

The flange portion 42 extends outward from the insertion portion 41. The insertion portion 41 has a first end portion 41a, which is one end portion in the axial direction of the insertion portion 41, and a second end portion 41b, which is an end portion on the opposite side to the first end portion 41a in the axial direction. The flange portion 42 is provided at the first end portion 41a of the insertion portion 41. The flange portion 42 is formed, for example, in an annular shape that is continuous around the entire circumference of the insertion portion 41. The flange portion 42 faces the attachment end portion 12a of the exterior member 12 in the lengthwise direction of the exterior member 12. That is to say, the flange portion 42 is interposed between the attachment end portion 12a and the electric wires 21. Accordingly, the flange portion 42 keeps the electric wires 21 from interfering with the attachment end portion 12a.

### Earth Wire Holding Portion 44

The earth wire holding portion 44 is provided, for example, in the insertion portion 41 of the holder 13. The earth wire holding portion 44 is formed to extend through the circumference wall that forms the insertion portion 41 in the radial direction, for example. The earth wire holding portion 44 is formed in a slit shape that extends, for example, from the second end portion 41b of the insertion portion 41 along the axial direction of the insertion portion 41. That is to say, the earth wire holding portion 44 is open in the second end portion 41b of the insertion portion 41 in the axial direction of the insertion portion 41. The earth wire holding portion 44 clamps a portion in the extending direction of the earth wire 26.

The earth wire 26 is passed from the inside of the insertion portion 41 to the outside. In addition, the earth wire 26 is passed through the slit 33 of the exterior member 12. That is to say, the earth wire 26 is pulled out from the inside of the insertion portion 41 to the outside of the exterior member 12 through the earth wire holding portion 44 and the slit 33 of the exterior member 12. Note that the slit 33 of the exterior member 12 may be blocked, for example, by being wrapped with tape, except for a portion of the slit 33 to which the holder 13 is attached, on the exterior member 12.

### Fixed Piece 43 and Fastening Member 51

The fixed piece 43 of the holder 13 extends from the flange portion 42 along the lengthwise direction of the exterior member 12. The flange portion 42 is provided between the fixed piece 43 and the insertion portion 41. The fixed piece 43 is fastened and fixed along with the electric wires 21 by a fastening member 51. The fixed piece 43 is, for example, formed in the shape of a circular arc centered on the axial line of the insertion portion 41 as viewed from the axial direction of the insertion portion 41. The fastening member 51 fixes the electric wires 21 and the fixed piece 43 in a state where the electric wires 21 are in contact with the inner surface of the fixed piece 43.

As shown in FIG. 1, the wire harness 10 includes the fastening member 51 that fixes the holder 13 to the electric wires 21. The fastening member 51 is, for example, adhesive tape or a cable tie. The fastening member 51 fastens the fixed piece 43 of the holder 13 and the electric wires 21 together from outside. Accordingly, the fixed piece 43 and the electric wires 21 are fixed to each other.

Operations in the first embodiment will be described.

The holder 13 is provided at a position where the earth wire 26 of the braided member 22 is provided. The fixed piece 43 of the holder 13 is fixed to the electric wires 21 and is also attached to the attachment end portion 12a of the exterior member 12. The earth wire 26 is held by the earth wire holding portion 44 of the holder 13. The earth terminal 14 attached to the earth wire 26 is fixed to the grounding member. Accordingly, radiation of noise from the electric wires 21 is favorably suppressed by the braided member 22.

Effects of the first embodiment will be described.
(1-1) The holder 13, which is fixed to the electric wires 21, includes the earth wire holding portion 44 that holds a portion in the extending direction of the earth wire 26. With this configuration, the holder 13 fixed to the electric wires 21 is provided with the earth wire holding portion 44, and thus the position of the earth wire 26 relative to the electric wires 21 can be stabilized. For this reason, the impedance in a region extending from the tubular portion 25 of the braided member 22 to the earth terminal 14 connected to the grounding member is stabilized. Therefore, shielding performance is stabilized.
(1-2) The wire harness 10 includes the cylindrical exterior member 12 (cylindrical exterior cover) that covers the electric wire member 11. The holder 13 provided with the earth wire holding portion 44 is attached to the attachment end portion 12a, which is one end portion in the lengthwise direction of the exterior member 12. Accordingly, the earth wire 26 extending from the braided member 22 can be held in the vicinity of the end portion in the lengthwise direction of the exterior member 12.
(1-3) The holder 13 includes the cylindrical insertion portion 41 (cylindrical insertion) that is inserted into the exterior member 12, and the flange portion 42 (flange) that extends outward from the insertion portion 41. The electric wires 21 pass through the insertion portion 41. The flange portion 42 faces the attachment end portion 12a in the lengthwise direction of the exterior member 12. With this configuration, the flange portion 42 of the holder 13 can keep the electric wires 21 from interfering with the attachment end portion 12a of the exterior member 12.
(1-4) The earth wire holding portion 44 is formed to extend through the insertion portion 41 in the radial direction. The earth wire 26 is passed from the inside of the insertion portion 41 to the outside. With this configuration, the earth wire 26 can be passed through the insertion portion 41 of the holder 13 to the outside of the insertion portion 41.
(1-5) The exterior member 12 includes the slit 33 through which the earth wire 26 is passed. With this configuration, the earth wire 26 can be passed through the slit 33 of the exterior member 12 to the outside of the exterior member 12.
(1-6) The wire harness 10 includes the fastening member 51 that fixes the holder 13 to the electric wires 21. The holder 13 includes the fixed piece 43 that is fastened and fixed along with the electric wires 21 by the fastening member 51. With this configuration, since the holder 13 is fixed to the electric wires 21 by the fastening member 51, it is possible to more stably hold the holder 13 and the earth wire 26 held by the earth wire holding portion 44 of the holder 13.

### Second Embodiment

A wire harness according to a second embodiment will be described below. In the present embodiment, differences from the first embodiment will be mainly described, and the same reference numerals are given to configurations that are the same as or correspond to those of the first embodiment, and a portion or all of the description of such configurations may be omitted.

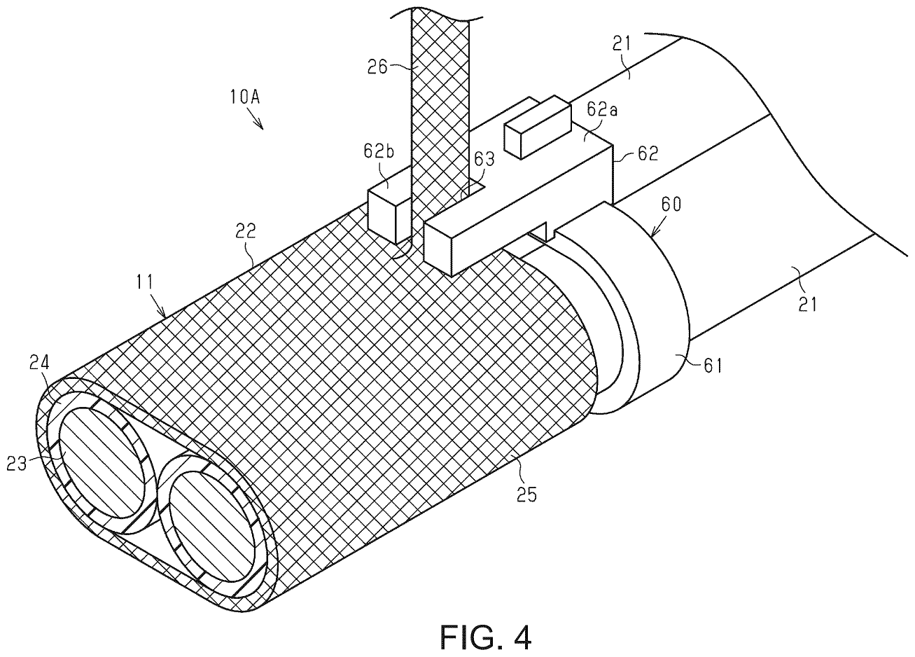

As shown in FIG. 4, a wire harness 10A according to the second embodiment includes a cable tie 60 that functions as a holder that is fixed to the electric wires 21. The cable tie 60 is made of, for example, a synthetic resin. The cable tie 60 bundles a plurality of electric wires 21. The cable tie 60 is configured to be attachable to the electric wires 21 from outside of the electric wires 21.

The cable tie 60 includes a band portion 61 (band) that is wound around the electric wires 21, and a lock portion 62 (lock) that is provided integrally with a base end portion in the lengthwise direction of the band portion 61 and is locked with the band portion 61 whose leading end portion is inserted into the lock portion 62.

The band portion 61 is formed in an elongated shape, and is flexible. On the band portion 61, a plurality of protruded portions (not shown) are arranged in parallel along the lengthwise direction of the band portion 61.

The lock portion 62 includes a lock portion body 62a and an extended portion 62b extending from the lock portion body 62a in the lengthwise direction of the electric wire member 11. The band portion 61 is inserted into the lock portion body 62a. In a state where the band portion 61 is passed through the lock portion body 62a, the lock portion body 62a is locked with the protruded portions of the band portion 61 in such a manner as to restrict movement of the band portion 61 in the removal direction, which is opposite to the direction in which the band portion 61 is passed through the lock portion body 62a. By the leading end portion of the band portion 61 being inserted into the lock portion body 62a and locked with the lock portion body 62a, the band portion 61 gathers and fastens the electric wires 21 from outside. Accordingly, the electric wires 21 are bundled together.

The cable tie 60 includes an earth wire holding portion 63 that holds a portion in the extending direction of the earth wire 26. The earth wire holding portion 63 is provided, for example, in the extended portion 62b of the lock portion 62. The extended portion 62b faces the tubular portion 25 of the braided member 22 in a direction orthogonal to the lengthwise direction of the electric wire member 11.

The earth wire holding portion 63 is formed to extend through the extended portion 62b in a direction orthogonal to the lengthwise direction of the electric wire member 11. For example, the earth wire holding portion 63 has a slit-like shape extending along the lengthwise direction of the electric wire member 11. The earth wire holding portion 63 is open in the lengthwise direction at a leading end portion of the extended portion 62b in the lengthwise direction of the electric wire member 11. The earth wire holding portion 63 clamps a portion in the extending direction of the earth wire 26.

Effects of the second embodiment will be described.
(2-1) The cable tie 60 fixed to the electric wires 21 includes the earth wire holding portion 63 that holds a portion in the extending direction of the earth wire 26. With this configuration, since the earth wire holding portion 63 is provided in the cable tie 60 fixed to the electric wires 21, the position of the earth wire 26 relative to the electric wires 21 can be stabilized. As a result, the impedance in a region extending from the tubular portion 25 of the braided member 22 to the earth terminal 14 that is connected to the grounding member is stabilized. Thus, the shielding performance is stabilized.
(2-2) The cable tie 60 includes the band portion 61 that is wound around the electric wires 21, and the lock portion 62 that is provided integrally with a base end portion in the lengthwise direction of the band portion 61, and is locked when a leading end portion of the band portion 61 is inserted into the lock portion 62. In addition, the earth wire holding portion 63 is provided in the lock portion 62. With this configuration, the position of the earth wire 26 relative to the electric wires 21 can be stabilized by the earth wire holding portion 63 provided in the cable tie 60 for binding the electric wires 21.

### Other Embodiments

The above embodiments can be modified and implemented as follows. The above embodiments and the following modified examples can be combined unless they are technically inconsistent.
The configuration of the holder 13, including the shape of the holder 13, is not limited to that of the first embodiment above, and can be changed as appropriate in accordance with the configuration of the wire harness 10.

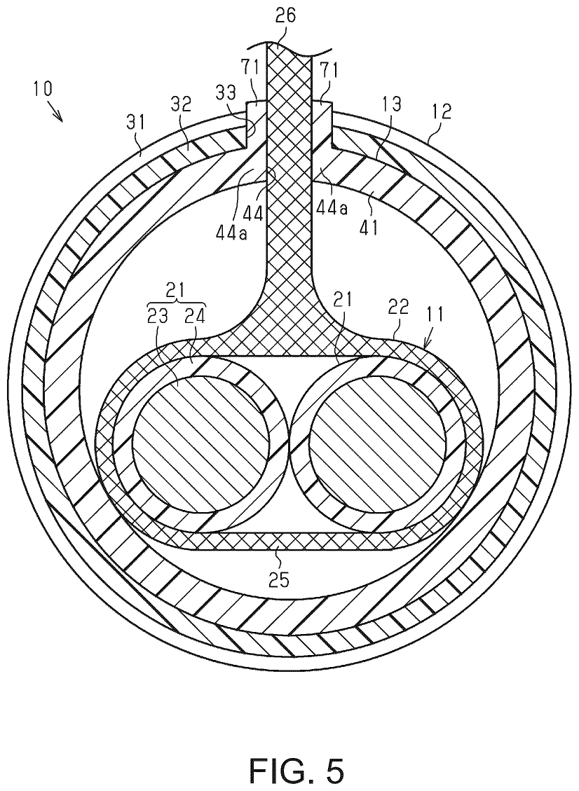

For example, as shown in FIG. 5, the earth wire holding portion 44 of the holder 13 may include positioning portions 71 that are inserted into the slit 33 of the exterior member 12. The positioning portions 71, for example, protrude outward from a pair of clamping portions 44a of the insertion portion 41 that clamp the earth wire 26 in the earth wire holding portion 44. The positioning portions 71 of the earth wire holding portion 44 also clamp the earth wire 26, for example.

By being inserted into the slit 33, the positioning portions 71 are engaged with the slit 33 in the circumferential direction of the exterior member 12. Accordingly, the exterior member 12 and the holder 13 are positioned relative to each other in the circumferential direction of the exterior member 12. Therefore, the position of the slit 33 relative to the electric wire member 11 in the circumferential direction, that is to say, the pull-out position of the earth wire 26 can be determined.
In the first embodiment above, the earth wire holding portion 44 of the holder 13 may be formed in a hole shape that extends through the circumferential wall forming the insertion portion 41 in the radial direction. That is to say, the earth wire holding portion 44 may have a shape that is not open in the axial direction of the insertion portion 41.
In the first embodiment above, the earth wire holding portion 44 may be provided in a portion of the holder 13 other than the insertion portion 41, such as the flange portion 42.
In the above first embodiment, the flange portion 42 of the holder 13 may be partially provided in the circumferential direction of the insertion portion 41.
In the first embodiment above, the exterior member 12 of the wire harness 10 may be, for example, a pipe-shaped member having a uniform diameter in the lengthwise direction, instead of a corrugated tube.
In the first embodiment, for example, a through hole that extends through the circumferential wall of the exterior member 12 in the radial direction may be provided in place of the slit 33 of the exterior member 12. In this case, the earth wire 26 is pulled out of the exterior member 12 through the through hole of the exterior member 12.
The wire harness 10A according to the second embodiment may include an exterior member such as a corrugated tube that covers the tubular portion 25 of the braided member 22, or does not need to include such an exterior member.
The number of electric wires 21 is not limited to the above embodiments, and may be only one or three or more.
In the above embodiments, the earth terminal 14 is described as being crimped to the earth wire 26, but there is no limitation thereto. For example, the earth terminal 14 may be connected to the earth wire 26 by another configuration such as welding or screwing.
Although not particularly described in the above embodiments, the earth wire 26 may be insulated, for example, by winding insulating tape around the earth wire 26.
In the illustrated wire harness 10 according to the non-limiting embodiments, the tubular portion 25 of the braided member 22 may be referred to as a large-diameter braided tube or a braided sheath. The earth wire 26 of the braided member 22 may be referred to as a small-diameter braided tube or a braided earth branch wire. The earth wire holding portions 44 and 63 of the holder 13 are examples of earth wire pinching clips, which are configured to set or roughly designate a pull-out position, a pull-out angle, and/or a pull-out direction of the earth wire 26 of the braided member 22 from the tubular portion 25 of the braided member 22, by coming into direct contact with or clamping a base end portion of the earth wire 26 of the braided member 22.
The embodiments and modified examples disclosed herein are examples in all respects, and the present disclosure is not limited to these examples. That is to say, the scope of the present disclosure is indicated by the claims, and is intended to include all modifications that are within the meanings and the scope that are equivalent to those of the claims.

1. A wire harness comprising:
an electric wire;
a braid formed by braiding conductive strands; and
an earth terminal,
wherein the braid includes a tube that covers the electric wire, and an earth wire that extends, while gathering strands of the earth wire together, from an end of the tube in such a manner as to be separable away from the electric wire, and be connected to the earth terminal; and
a holder that is fixed to the electric wire,
wherein the holder includes an earth wire holder that holds a portion in an extending direction of the earth wire.

2. The wire harness according to claim 1, further comprising:
a cylindrical exterior cover that covers the member, electric wire and the braid,
wherein the holder is attached to an attachment end that is one end in a lengthwise direction of the exterior cover.

3. The wire harness according to claim 2, wherein:
the holder includes: a cylindrical insertion that is inserted into the exterior cover, and a flange that extends outward from the insertion,
the electric wire passes through the insertion, and
the flange faces the attachment end in the lengthwise direction of the exterior cover.

4. The wire harness according to claim 3, wherein:
the earth wire holder is formed to extend through the insertion in a radial direction, and
the earth wire is passed from inside of the insertion to outside.

5. The wire harness according to claim 4,
wherein the exterior cover includes a slit through which the earth wire is passed.

6. The wire harness according to claim 5,
wherein the earth wire holder includes a positioning portion engaging with the slit in a circumferential direction when inserted into the slit.

7. The wire harness according to claim 2, further comprising
a fastening member fixing the holder to the electric wire,
wherein the holder includes a fixed piece that is fastened and fixed along with the electric wire by the fastening member.

8. The wire harness according to claim 1, further comprising:
a plurality of electric wires that includes the electric wire, wherein:
the holder is a cable tie bundling the plurality of electric wires,
the cable tie includes a band that is wound around the electric wires, and a lock provided integrally with a base end in a lengthwise direction of the band, and locked with the band whose leading end is inserted into the lock, and
the earth wire holding holder is provided in the lock.
